(19) United States
(12) Patent Application Publication
(10) Pub. No.: US 2011/0258771 A1
(43) Pub. Date: Oct. 27, 2011

(54) SEAT TILT MECHANISM FOR CHAIRS USED BY PEOPLE WITH DISABILITIES

(75) Inventors: Bruce R. Hammer, San Rafael, CA (US); David F. Gaskell, Vallejo, CA (US)

(73) Assignee: NUPRODX, INC., San Rafael, CA (US)

(21) Appl. No.: 13/093,637

(22) Filed: Apr. 25, 2011

Related U.S. Application Data
(60) Provisional application No. 61/324,187, filed on Apr. 26, 2010.

(51) Int. Cl. A47K 17/00; B23P 17/04; A61G 15/00; A47C 1/02; A47C 1/00

(52) U.S. Cl. 4/667; 297/313; 29/428

(57) ABSTRACT

This application provides a mechanism that consists of right and left mounting bases that in different embodiments are adapted for mounting on a variety of different chairs. These mechanisms have roller tracks that have been designed on a radius with the fulcrum or pivot point positioned very close to where the center of mass is located, for a wide spectrum of different sized people from children through over-sized adults, to achieve varying degrees of movement. On the inside of the left and right mounting bases are curved slots that are parallel to the curvature of the roller tracks where guide members on the front and rear mounting brackets keep the seat and back rest from coming off the chair. There are front and rear rollers that traverse within the roller tracks that pivot on axles in the front and rear mounting brackets. In the curved slots on the sides are adjustable stop pins that limit the tilt or travel of the seat and back rest. A rack and spur gear mechanism is incorporated to manually adjust the position of the seat and back rest of the chair by rotating a crank handle. By removing the rack and spur gear mechanism and adjusting the stop pins the device will perform as a rocking chair. Turning a friction locking knob will lock the seat and back into a stationary position.

### FIELD OF THE INVENTION

The seat tilt mechanism for chairs used by people with disabilities relates to devices used by handicapped or physically impaired individuals. More specifically this application provides a unique mechanism that allows a handicapped person or the caregiver, using a variety of different styles of chairs including wheelchairs, to easily tilt the seat and backrest portion into various positions when the person is seated in the chair, no matter how heavy they are, and lock it into position.

### BACKGROUND OF THE INVENTION

People who have to spend extended periods of time in chairs designed for people with disabilities often complain of discomfort in their back, and are also susceptible to pressure sores and/or skin problems on their posteriors, due to being in an up-right position all the time. These people often use pillows to make adjustment in their position in the chairs to decrease the pressures on their body. Additionally some people in the upright position require restraints due to the tendency of leaning forward with the possibility of falling out of the chair. Office chairs are most often designed with a tilt mechanism due to the fact that by leaning back it relieves some of the pressures incurred when sitting in the upright position for extended periods of time. Most chairs that have been designed to tilt have the pivot point at the rear where a great deal of force is required to reposition the person in the chair or the person needs to be removed from the chair to make any adjustments and then put back into the chair to see if the adjustments were correct. The chairs that pivot at the rear are required to extend the back wheels to keep the persons' weight centered over the wheels. Often slight adjustments need to be frequently made over a period of time for the comfort of the person in the chair. These periodic adjustments are best made by the person in the chair, if possible. An additional problem occurs when the seat is pivoted at the back; it extends the length of the chair from front to back making it less manageable in tight locations.

The unique benefit of the tilt-in-space design is that the fulcrum or pivot point of the curved tracks on which the seat is attached is very close to where an average adult's center of mass would be when seated in the chair. Therefore, rotation of the person while seated in the chair takes very little force to rotate as compared to other chairs that rotate from a fixed hinge point at the back of the chair. With the hinge point at the back it requires a fair amount of force to tilt an adult and does not make it possible for the person in the chair to easily make adjustments themselves. Different radii of the curved tracks can be used still having the fulcrum or pivot point very close to where the center of mass is located, for a wide spectrum of different sized people from children through over-sized adults, to achieve varying degrees of movement, and will be covered within the scope of this application.

The seat tilt mechanism for chairs used by people with disabilities has a unique side mounted hand crank and locking assembly. Side mounting is critical in providing access for care giver or user. All of the prior art references mentioned below provide a rear facing tilt adjustment only, which is very difficult for care givers to gain access, or impossible for users to gain access. The present hand crank assembly drives a rack and spur gear mechanism that allows a person, either the user in the chair or the care-giver, the ability to easily make adjustments. This is due to the center of rotation being close to the user's center of mass and the mechanical advantage that can be achieved. With different gear sizes and/or lever handle lengths, the person in the chair can tilt themselves into various positions.

Numerous innovations in the design of chairs for people with disabilities have been provided in the prior art that are described as follows. Even though these innovations may be suitable for the specific individual purposes to which they address, they differ from the present design as hereinafter contrasted. The following is a summary of those prior art patents most relevant to this application at hand; as well as a description outlining the difference between the features of the seat tilt mechanism for chairs used by people with disabilities and the prior art.

U.S. Pat. No. 5,667,235 of Tony M. Pearce et al. describes a multi-adjustable wheelchair with adjustability features which accommodate the physical size and comfort of the wheelchair user is disclosed and claimed. The wheelchair includes wheelchair frame width adjustment, wheelchair rear axle position adjustment, wheelchair seat height and bucketing angle adjustment, wheelchair seat base width and length adjustment, wheelchair seat back angle adjustment and wheelchair seat fore and aft position adjustment.

This patent describes a multi-adjustable wheelchair with adjustability features. It has been designed as a complete wheelchair unit, but does not provide a device that can be used on a variety of other different styles of wheelchairs or stationary chairs to achieve a tilting or rocking application. It does exemplify the need for adjustability in chairs used for people with disabilities to provide greater comfort and safety.

U.S. Pat. No. 5,944,338 of Maurice Simpson relates to a wheelchair that is comprised of a foldable chair, having a selectively inclinable back support, fixedly or removably attached to a castor-based platform. A foot-rest is slidably attached to the platform. A padded walker and a padded head rest each having height adjustment capabilities are each removably attachable to the wheelchair. A leg-rest having incline capability above and below the horizontal is removably attachable to the wheelchair. A selectively inclinable tray is removably attachable to the wheelchair. A toilet assembly is removably attachable to the wheelchair.

This patent relates to a wheelchair that is comprised of a foldable chair, having a selectively inclinable back support but is also been designed as a complete wheelchair unit, but does not provide a device that can be used on a variety of other different styles of wheelchairs or stationary chairs.

U.S. Pat. No. 7,014,204 of Danny Myers et al. describes a rocking wheelchair that is provided with multiple adjustable features to meet various needs of different users with respect to safety, comfortableness and user/caregiver convenience. The rocking wheelchair includes an adjustable maximum rocking motion setting for users to select a preferable maximum rocking motion within a predetermined safety range. Rock/tilt locking mechanisms enable the seat assembly to be locked in either a normally unoccupied position or one of a plurality of tilt positions. The footrests can be selectively attached to either the frame for supporting the user's feet in a stationary position, or to the seat assembly to rock together therewith. The wheelchair can also be adjusted in height and is formed with a relatively simple configuration which is convenient for manufacturing.

This patent describes a rocking wheelchair that is provided with multiple adjustable features to meet various needs of different users. This is still another wheelchair that has been designed as a complete wheelchair unit, but does not provide a device that can be used on a variety of other different styles of wheelchairs or stationary chairs

U.S. Pat. No. 7,306,251 of Anthony D. Bright et al. tells of a wheelchair that has a reclined configuration and an upright configuration. In the upright configuration, the seat of the wheelchair is at least substantially perpendicular to a back support and located at a first elevation. An actuator is useful to lift the seat during the movement to the reclined configuration to a second elevation higher than the first elevation. Outriggers move to load bearing position in the reclined configuration to assist in supporting weight on the back support. An installed lifter is useful in assisting patient movement to and from the wheelchair.

This patent tells of a wheelchair that has a reclined configuration and an upright configuration. This is yet another wheelchair that has been designed as a complete wheelchair unit, but does not provide a device that can be used on a variety of other different styles of wheelchairs or stationary chairs

US Patent Application Publication No. 2006/0236449 of Bruce R. Hammer et al. discloses a bath transfer system comprising: a) a chair portion for the purpose of enabling a user to be positioned adjacent to a bathtub, said chair portion containing a base portion and an upper portion, said base portion containing at least two chair portion track members having a continuous groove on one side and at least two chair portion support members attached to said at least two chair portion track members, said upper portion containing an upper chassis, a backrest portion attached to said upper chassis, and a chair seat attached to said upper chassis; b) a connector portion removably attached on one end to said chair portion, said connector portion containing at least two connector portion track members having a continuous groove on one side; c) a bathtub portion removably attached to the other end of said connector portion, said bathtub portion containing at least two bathtub track members having a continuous groove on one side and at least two bathtub portion support members attached to said at least two bathtub track members; and d) rolling means attached to said upper chassis for the purpose of allowing said upper chassis to translate along said continuous groove of said at least two chair portion track members, said continuous groove of said at least two connection portion track members, and said continuous groove of said at least two bathtub track members whereby a user can be placed into said chair portion for transport to the bathroom and utilization of the commode, and if the user desires to bathe, the user can be positioned adjacent to a bathtub having said bathtub portion located therein, without having to change apparatus, wherein said connector portion is then attached on one end to said chair portion and on the other end to said bathtub portion, thus creating a continuous track that allows said upper chassis to translate from said chair portion to over said bathtub portion, after which said connector portion can be removed and a curtain can be drawn around the bathtub to allow the user to bathe in privacy.

This patent by the inventor of the device in this application discloses a bath transfer system comprising a chair portion for the purpose of enabling a user to be positioned adjacent to a bathtub but does not incorporate a tipping or rocking capability of the seat tilt mechanism for chairs used by people with disabilities disclosed in this application.

In this respect, before explaining at least one embodiment of the seat tilt mechanism for chairs used by people with disabilities in detail it is to be understood that the design is not limited in its application to the details of construction and to the arrangement, of the components set forth in the following description or illustrated in the drawings. The seat tilt mechanism for chairs used by people with disabilities is capable of other embodiments and of being practiced and carried out in various ways. In addition, it is to be understood that the phraseology and terminology employed herein are for the purpose, of description and should not be regarded as limiting. As such, those skilled in the art will appreciate that the conception, upon which this disclosure is based, may readily be utilized as a basis for designing of other structures, methods and systems for carrying out the several purposes of the present design. It is important, therefore, that the claims be regarded as including such equivalent construction insofar as they do not depart from the spirit and scope of the present application.

### SUMMARY OF THE INVENTION

The principal advantage of the seat tilt mechanism for chairs used by people with disabilities is the enabling of a person sitting in a variety of different chairs to easily reposition the seat and back rest into various tilted, reclined and inclined positions.

Another advantage of the seat tilt mechanism for chairs used by people with disabilities is that a caregiver also can easily reposition the seat and back rest into different inclining positions while the person is sitting in the chair.

Another advantage of the seat tilt mechanism for chairs used by people with disabilities is that the fulcrum or pivot point of the curved tracks has been positioned very close to where an average adult's center of mass would be when seated in the chair.

Another advantage of the seat tilt mechanism for chairs used by people with disabilities is that when the fulcrum or pivot point of the curved tracks has been positioned very close to where an average adult's center of mass is in the chair, the back wheels of the chair do not need to be extended to center the persons weight between the wheels while in the tilted position in the chair.

Another advantage of the seat tilt mechanism for chairs used by people with disabilities is that when in the tilted position it only lengthens the front to back distance slightly.

A further advantage of the seat tilt mechanism for chairs used by people with disabilities is that it is equally as easy to operate with a very heavy person in the chair as it is with a light weight person, that is, the gear size or lever handle can be adjusted so that it is equally as easy to operate with a very heavy person in the chair as it is with a very light person.

Yet another advantage with different embodiments of the seat tilt mechanism for chairs used by people with disabilities is that it will work with a wide variety of sizes and shapes of chairs.

Another advantage of the seat tilt mechanism for chairs used by people with disabilities is that it can be locked in any position by the means of a friction locking knobs.

Another advantage of the seat tilt mechanism for chairs used by people with disabilities is that when in use with the locking handle, the spring loaded locking hand crank automatically locks if the user releases the lever, enabling one-handed operation.

Another advantage of the seat tilt mechanism for chairs used by people with disabilities is that in the rocking embodiment the chair can still be locked in various positions by the means of the friction locking knobs.

These together with other advantages of the seat tilt mechanism for chairs used by people with disabilities, along with the various features of novelty, which characterize the design, are pointed out with particularity in the claims annexed to and forming a part of this disclosure. For a better understanding of the seat tilt mechanism for chairs used by people with disabilities, its operating advantages and the specific objects attained by its uses, reference should be made to the accompanying drawings and descriptive matter in which there are illustrated preferred embodiments of the seat tilt mechanism for chairs used by people with disabilities. There has thus been outlined, rather broadly, the more important features of the design in order that the detailed description thereof that follows may be better understood, and in order that the present contribution to the art may be better appreciated. There are additional features of the seat tilt mechanism for chairs used by people with disabilities that will be described hereinafter and which will form the subject matter of the claims appended hereto.

The seat tilt mechanism for chairs used by people with disabilities consists of right and left tilt mechanism bases that in different embodiments are adapted for mounting on a variety of different chairs. These mechanisms have roller tracks that have been designed on a radius with the fulcrum or pivot point positioned very close to where an average adult's center of mass would be when seated in the chair. Different radii will be available depending upon the size of the person and the desired travel of the chair seat and back rest. On the inside of the left and right mounting bases are curved slots that are parallel to the curvature of the roller tracks where guide members on the front and rear mounting brackets keep the seat and back rest from coming off of the chair. There are front and rear rollers that traverse within the roller tracks that pivot on the axles, in the front and rear mounting brackets. In the curved slots on the sides are adjustable stop pins that limit the tilt or travel of the seat and back rest of the chair. A rack and spur gear mechanism is incorporated to manually adjust the position of the seat and back rest of the chair by rotating the crank handle. By removing the rack and spur gear mechanism and adjusting the stop pins the device will perform as a rocking chair. Turning a friction locking knob will secure the seat and back rest into a stationary position. In an alternate embodiment, using a locking crank handle combines chair rotation and chair locking into a one-handed mechanism, and eliminates the need for a friction knob.

With respect to the above description then, it is to be realized that the optimum dimensional relationships for the parts of this application, to include variations in size, materials, shape, form, function and manner of operation, assembly and use, are deemed readily apparent and obvious to one skilled in the art. All equivalent relationships to those illustrated in the drawings and described in the specification intend to be encompassed by the present disclosure. Therefore, the foregoing is considered as illustrative only of the principles of the seat tilt mechanism for chairs used by people with disabilities. Further, since numerous modifications and changes will readily occur to those skilled in the art, it is not desired to limit the design to the exact construction and operation shown and described, and accordingly, all suitable modifications and equivalents may be resorted to, falling within the scope of this application.

### BRIEF DESCRIPTION OF THE DRAWINGS

The accompanying drawings, which are incorporated in and form a part of this specification, illustrate embodiments of the seat tilt mechanism for chairs used by people with disabilities and together with the description, serve to explain the principles of this application.

FIG. 1 depicts a perspective view of the seat tilt mechanism for chairs used by people with disabilities in a tipped configuration attached to a toileting chair with an over the tub track system.

FIG. 2 depicts a perspective view of the seat tilt mechanism for chairs used by people with disabilities in a tipped configuration attached to a toileting chair illustrating the location of the right side element.

FIG. 3A depicts an enlarged perspective view of the right side element of the seat tilt mechanism for chairs used by people with disabilities, showing the standard crank handle used in conjunction with the friction brake.

FIG. 3B depicts an enlarged perspective view of the right side element of the seat tilt mechanism for chairs used by people with disabilities, showing a locking crank handle used in conjunction with the friction brake.

FIG. 3C depicts an enlarged perspective view of the right side element of the seat tilt mechanism for chairs used by people with disabilities, showing the locking crank handle used alone.

FIG. 4 depicts a perspective view from the right side of the two components of the alternate embodiment of the seat tilt mechanism for chairs used by people with disabilities to accommodate different styles of chairs.

FIG. 5 depicts a perspective view from the left side of the two components of the alternate embodiment of the seat tilt mechanism for chairs used by people with disabilities to accommodate different styles of chairs.

FIG. 6 depicts a perspective view of the tilt adjustment rack and spur gear mechanism.

FIG. 7 depicts an exploded perspective view of the tilt adjustment rack and spur gear mechanism.

FIG. 8 depicts a perspective view of the seat tilt mechanism for chairs used by people with disabilities in an upright position.

For a fuller understanding of the nature and advantages of the seat tilt mechanism for chairs used by people with disabilities, reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

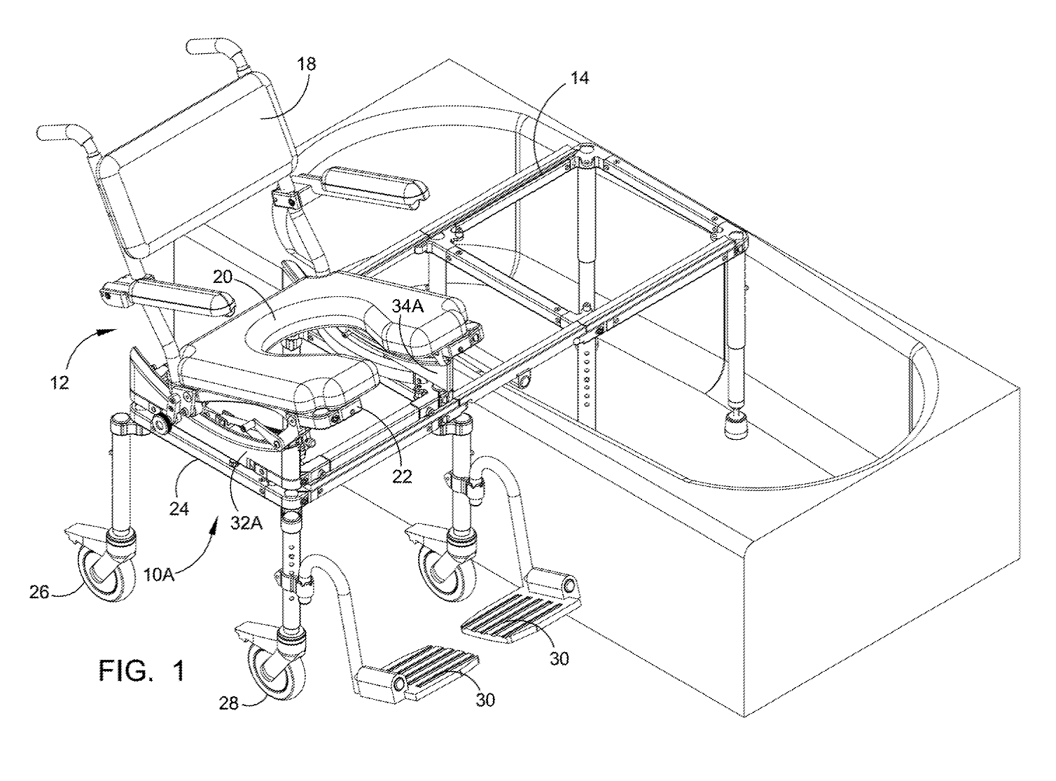

Referring now to the drawings, wherein similar parts of the seat tilt mechanism for chairs used by people with disabilities 10A and 10B are identified by like reference numerals. There is seen in FIG. 1 a perspective view of the seat tilt mechanism for chairs used by people with disabilities 10A in a tipped configuration attached to a toileting chair 12 with an over the tub track 14 system. It must be made clear at this time that the seat tilt mechanism for chairs used by people with disabilities 10A and 10B are not limited to the toileting style of chairs 12 for people with disabilities, but may be manufactured to fit on a wide variety of styles of chairs including the conventional wheelchairs. The toileting chairs 12 are generally composed of a back rest 18, a seat 20, a seat frame 22, and the chair base frame 24, rear wheels 26, front wheels 28 and foot rests 30. The right tilt mechanism base 32A and the left tilt mechanism base 34A of the seat tilt mechanism for chairs used by people with disabilities 10A are attached to the chair base frame 24. Foot rests 30 are height adjustable and can be readily swung out of the way of the user.

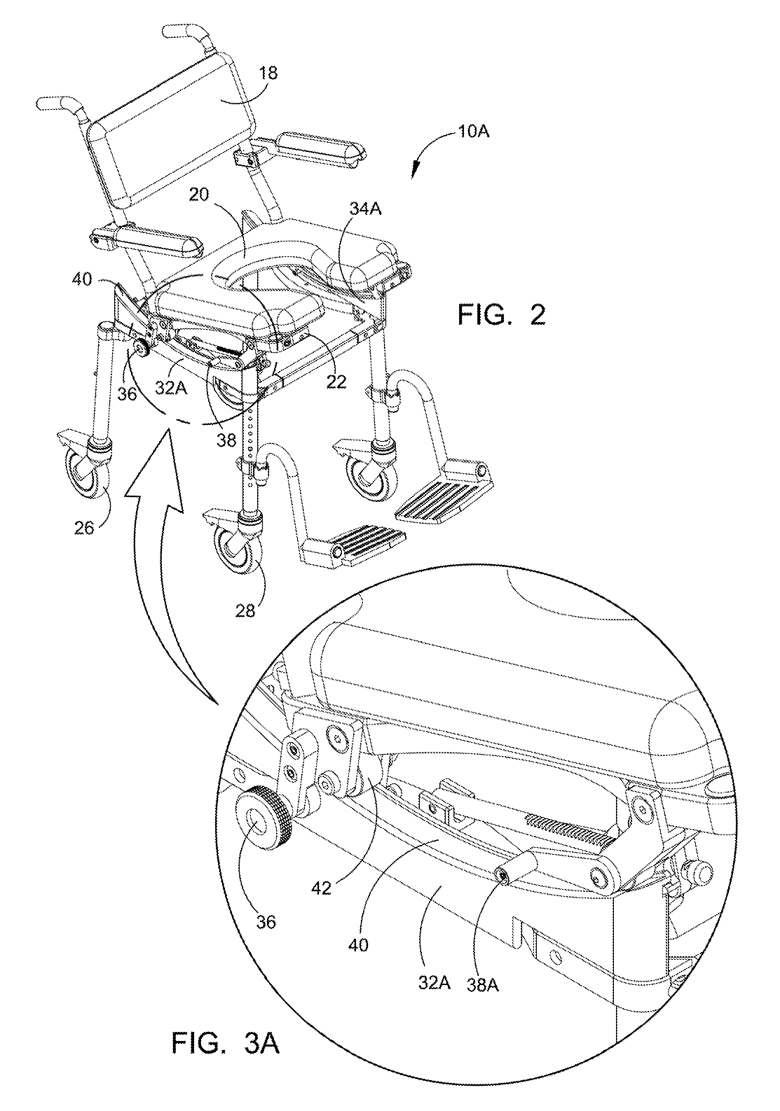

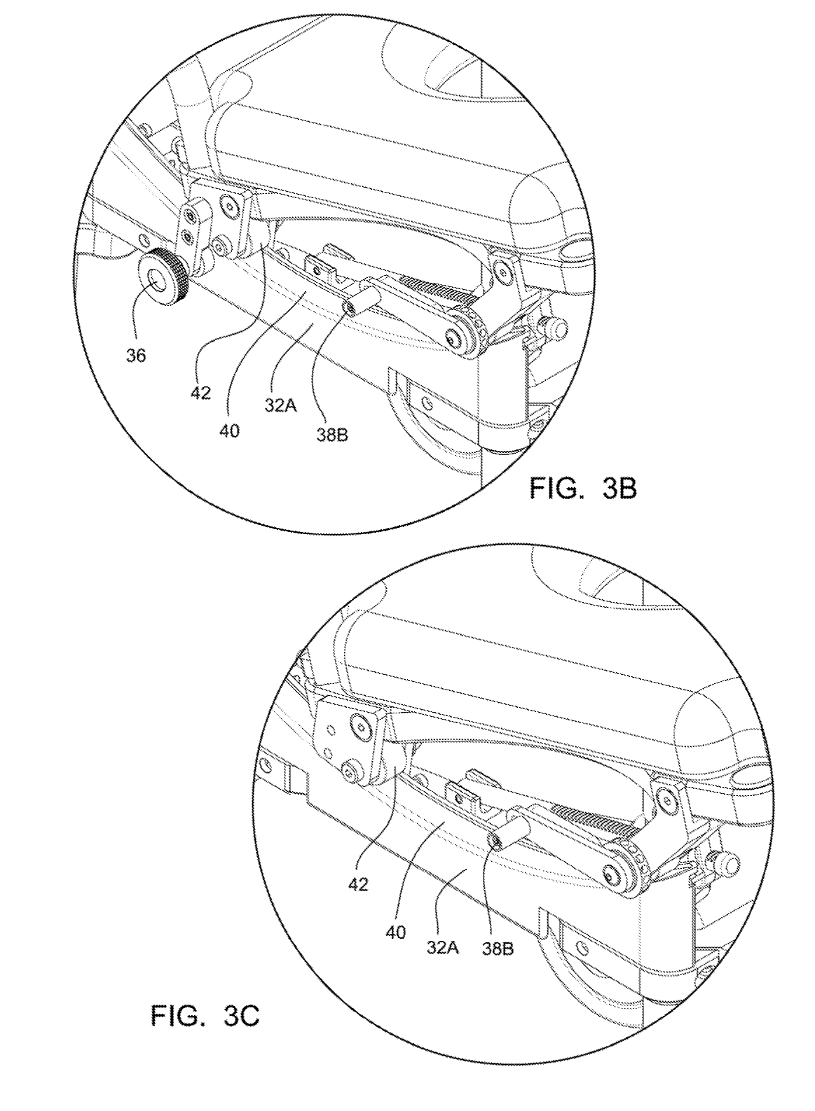

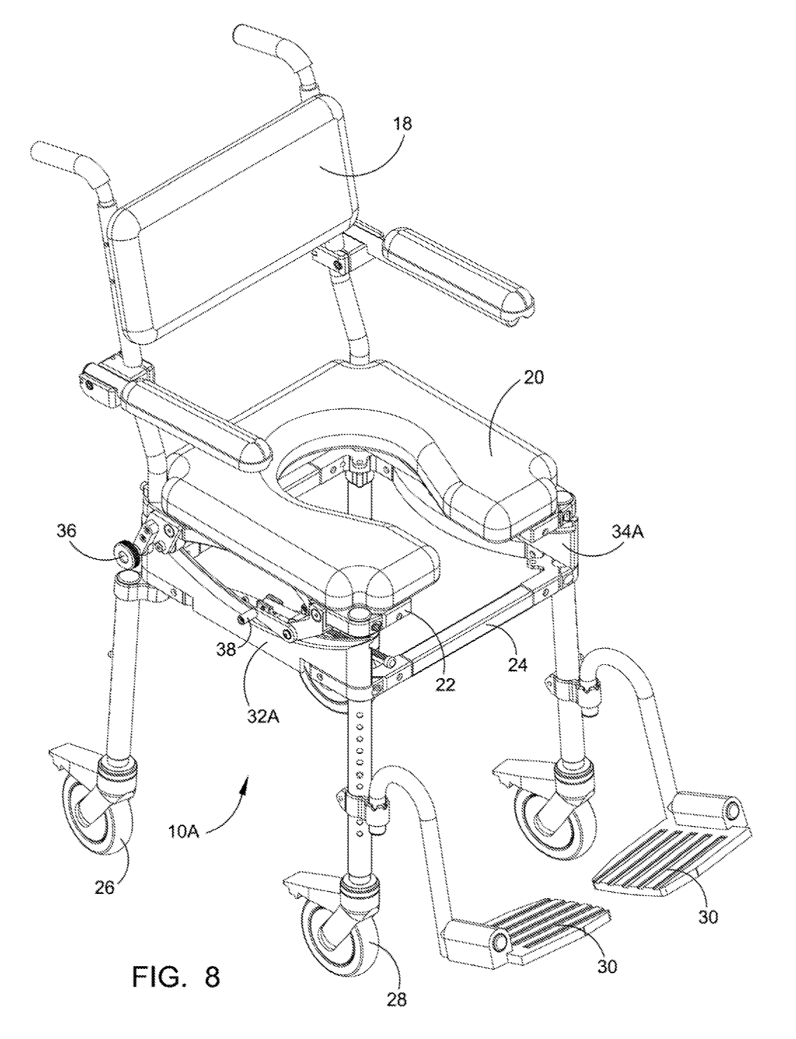

FIG. 2 depicts a perspective view of the seat tilt mechanism for chairs used by people with disabilities 10A in a tipped configuration attached to a toileting chair 12 illustrating the location of the right side tilt mechanism base 32A and the left tilt mechanism base 34A depicted in FIGS. 3A, 3B and 3C. Additionally, the armrests shown here and in FIG. 8 below, are pivotally attached to the toileting chair depicted, and can be swung upward and out of the way of the user.

FIGS. 3A, 3B and 3C have been enlarged to better illustrate the location of the right tilt mechanism base 32A, the friction locking knob 36, the standard crank handle 38A, the locking crank handle 38B, the roller track 40, and the rear roller 42. FIG. 3A depicts an enlarged perspective view of the right side element of the seat tilt mechanism for chairs used by people with disabilities, showing the standard crank handle 38A used in conjunction with the friction locking knob 36. FIG. 3B depicts an enlarged perspective view of the right side element of the seat tilt mechanism for chairs used by people with disabilities, showing a locking crank handle 38B used in conjunction with the friction locking knob 36. FIG. 3C depicts an enlarged perspective view of the right side element of the seat tilt mechanism for chairs used by people with disabilities, showing the locking crank handle 38B used alone. When used alone, this enables the user to adjust the seat tilt angle and lock the desired angle in place using one hand on locking handle 38B. In this regard, using the locking crank handle 38B enables one-handed operation.

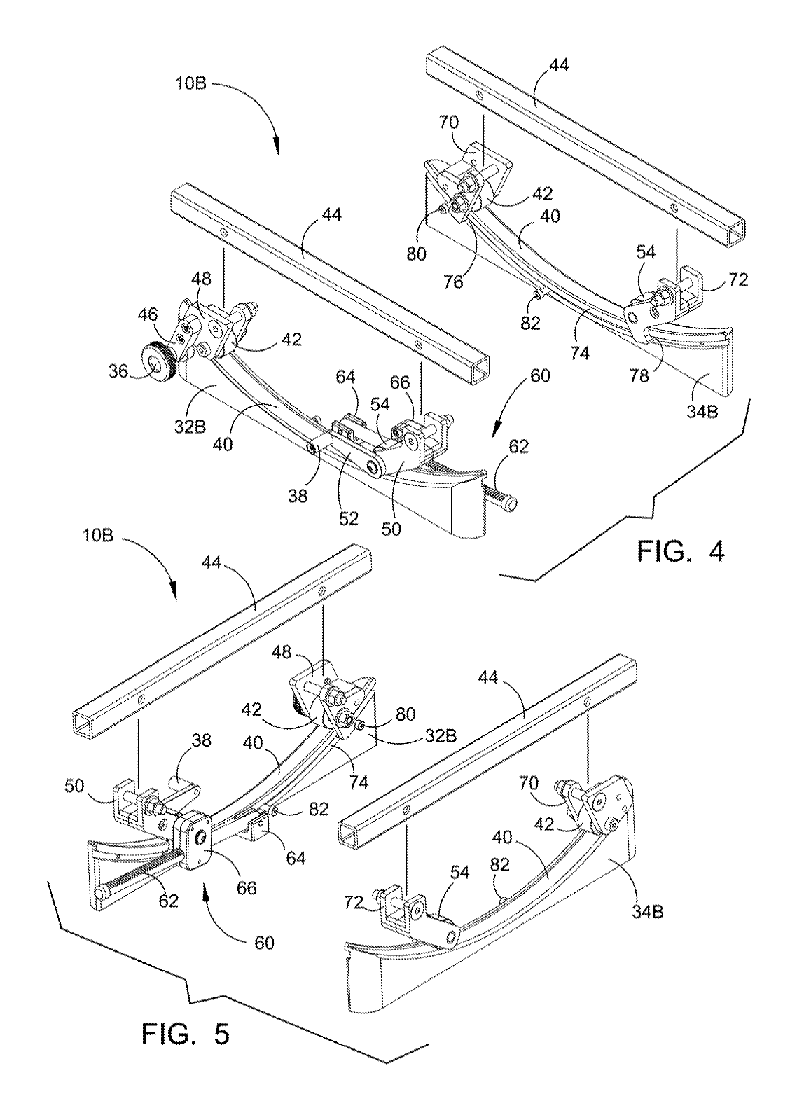

FIG. 4 depicts a perspective view from the right side of the two components of the alternate embodiment of the seat tilt mechanism for chairs used by people with disabilities 10B designed to accommodate different styles of chairs. The differences in the design of the seat tilt mechanism for chairs used by people with disabilities 10B are the lower surface of the right and left tilt mechanism bases 32B and 34B are flat to be attached to the flat surfaces of different chair designs. The square tubing 44 exploded away from the right and left tilt mechanism bases 32B and 34B are the optional attachment means to fit to a chair with a flat bottom surface. These illustrations further illustrate both sides of the right and left tilt mechanism bases 32B and 34B where the right mechanism base 32B has the roller track 40, the friction locking knob 36, the friction locking knob attachment plate 46, the rear mounting bracket 48, the rear roller 42, the front mounting bracket 50, with the crank handle 38, the crank handle arm 52 and the front roller 54. The rack and spur gear mechanism 60 consisting of a gear rack 62 pivotally attached to mounting block 64 that will be attached to the chair base frame 24, and the spur gear housing 66 is attached to the front mounting bracket 50.

The major components of the left side of the of the seat tilt mechanism for chairs used by people with disabilities 10B are basically symmetrical with the left side having the rear mounting bracket 70 and the left side front mounting bracket 72, with the omission of the rack and spur gear mechanism 60. A curved slot 74 that runs parallel to the curvature of the roller track 40 on both the right and left tilt mechanism bases 32B and 34B and works as a retainer where the rear guide member 76 on the rear mounting brackets 70 and forward guide member 78 on the front mounting bracket 72 hold the seat frame 22 from coming off the chair. Stop pins 80 and 82 are inserted into the curved slot 74 to limit the tilt travel of the seat 20 and back rest 18 of the device. An alternate embodiment of the seat tilt mechanism for chairs used by people with disabilities 10A and 10B would have the crank handle 38, the crank handle arm 52, and the rack and spur gear mechanism 60 removed and the position of the stop pins 80 and 82 relocated to facilitate a rocking motion to the seat 20 and back rest 18 of the device.

FIG. 5 depicts a perspective view from the left side of the two components of the alternate embodiment of the seat tilt mechanism for chairs used by people with disabilities 10B. This view more clearly illustrates the location of the rack and spur gear mechanism 60 consisting of a gear rack 62 pivotally attached to mounting block 64 that will be attached to the chair base frame 24, and the spur gear housing 66 attached to the front mounting bracket 50. The stop pins 80 and 82 in the curved slot 74 are clearly displayed on the right mechanism base 32B, where they are inserted into the curved slot 74 to limit the tilt travel of the seat 20 and back rest 18 of the device.

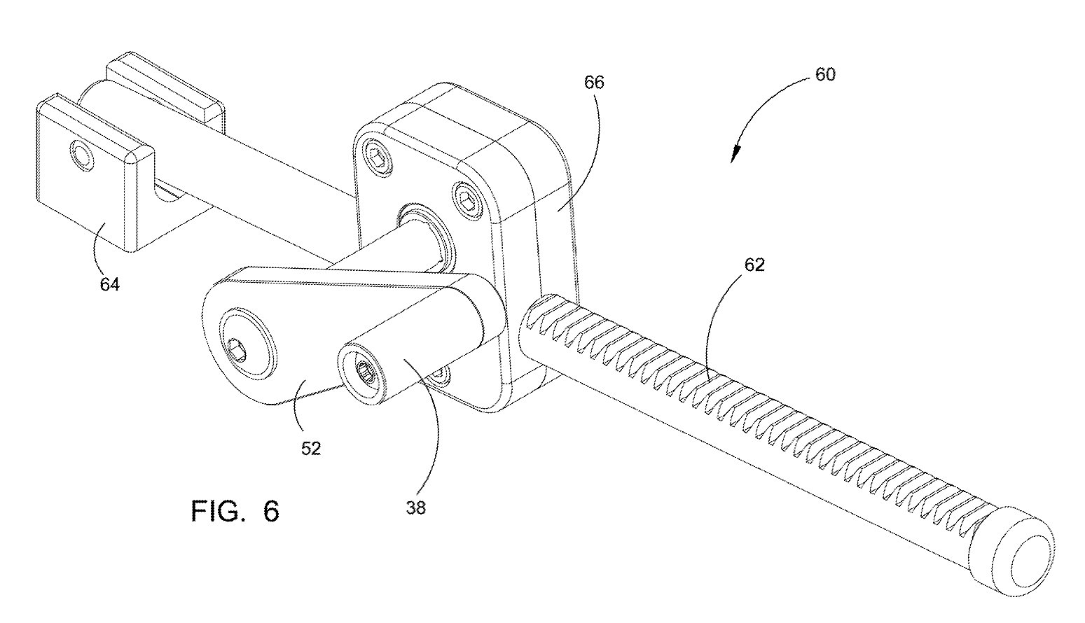

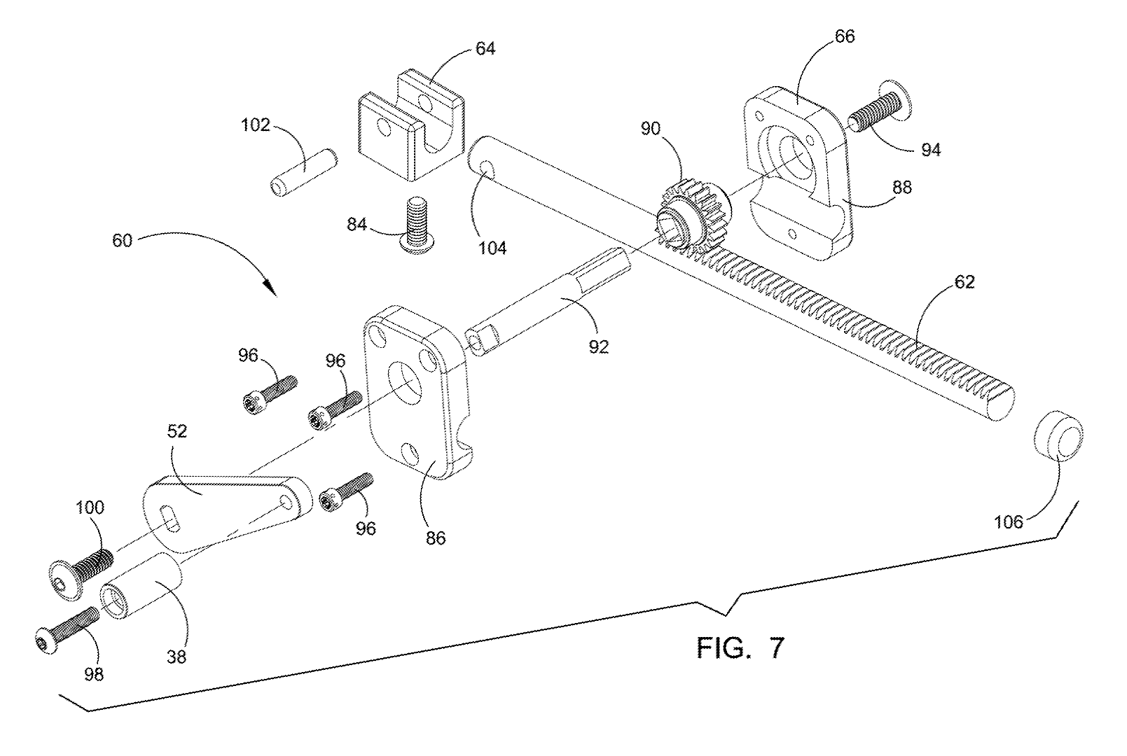

FIG. 6 depicts a perspective view of the assembled tilt adjustment rack and spur gear mechanism 60 with gear rack 62 pivotally attached to mounting block 64 that will be attached to the chair base frame 24 by the means of the screw 84, and the spur gear housing 66 attached to the front mounting bracket 50. FIG. 7 depicts an exploded perspective view of the tilt adjustment rack and spur gear mechanism 60 illustrating the front cover 86 and the rear cover 88 and the spur gear 90, the spur gear shaft 92 and the shaft retaining screw 94. The front cover 86 and the rear cover 88 of the spur gear housing 66 are held together by the means of three screws 96. The crank handle 38 is attached to the crank handle arm 52 by the means of the screw 98 with the crank handle arm 52 attached to the spur gear shaft 90 by the means of the screw 100. A pivot pin 102 is used in the mounting block 64 extending through the orifice 104 in the gear rack 62 that provides a pivoting means when the adjustments are made to the reposition of the device. An end cap 106 covers the end of the gear rack 62.

FIG. 8 depicts a perspective view of the seat tilt mechanism for chairs used by people with disabilities 10A in an upright position.

The seat tilt mechanism 10A or 10B can be readily moved from its current position on the right or left hand side of the chair for people with disabilities, to the opposite side, left or right, when conditions require. The following is a further explanation on reversing the crank from the right side to the left side, where the same procedure applies going from the left side to the right side:

1) Detach the pivot block from the frame or surface that it is mounted to (in the present case this is the lower shower chair frame);

2) Unscrew the flange head screw on the inside of the gear crank mechanism from the gear crank shaft;

3) Detach the gear crank handle and shaft as one unit from the crank mechanism by pulling the unit out from the crank handle side;

4) Slide without rotating the main gear mechanism to the inside of the opposite curved track;

5) Mount the pivot block; and

6) Line up the inside hole of the gear mechanism with axle hole on the front left side forks. Then insert the shaft with handle attached through the left side front fork axle hole then into the indexed (square or oval with flat edges) ID hole in the spur gear. Slide all the way through and then secure in place by screwing in the flange head screw.

The seat tilt mechanism for chairs used by people with disabilities 10A and 10B shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a seat tilt mechanism for chairs used by people with disabilities 10A and 10B in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A seat tilt mechanism for chairs used by people with disabilities comprising:
(a) right and left tilt mechanism bases, wherein said right mechanism base includes a roller track, a friction locking knob, a friction locking knob attachment plate, a rear mounting bracket, a rear roller, and a front mounting bracket, wherein said front mounting bracket includes a crank handle, a crank handle arm and a front roller;
(b) a rack and spur gear mechanism, and a spur gear housing attached to said front mounting bracket;
(c) a left side of the of the seat tilt mechanism being symmetrical with the right side having a rear mounting bracket and a left side front mounting bracket, with the omission of the rack and spur gear mechanism; and
(d) a curved slot that runs parallel to the curvature of the roller track on both the right and left tilt mechanism bases which functions as a retainer where the rear guide member on the rear mounting brackets and forward guide member on the front mounting bracket hold the seat frame from coming off the chair;
whereby said rack and spur gear mechanism is rotated using said crank handle to actuate tilting of the chair angle.

2. The seat tilt mechanism for chairs used by people with disabilities, according to claim 1, wherein said right and left tilt mechanism bases are reversed in position, wherein said left mechanism base includes a roller track, a friction locking knob, a friction locking knob attachment plate, a rear mounting bracket, a rear roller, and a front mounting bracket, wherein said front mounting bracket includes a crank handle, a crank handle arm and a front roller.

3. The seat tilt mechanism for chairs used by people with disabilities, according to claim 1, wherein said right mechanism base includes a roller track, a friction locking knob, a friction locking knob attachment plate, a rear mounting bracket, a rear roller, and a front mounting bracket, wherein said front mounting bracket includes a crank handle, further wherein said crank handle comprises a locking crank handle, a crank handle arm and a front roller.

4. The seat tilt mechanism for chairs used by people with disabilities, according to claim 2, wherein said left mechanism base includes a roller track, a friction locking knob, a friction locking knob attachment plate, a rear mounting bracket, a rear roller, and a front mounting bracket, wherein said front mounting bracket includes a crank handle, further wherein said crank handle comprises a locking crank handle, a crank handle arm and a front roller.

5. The seat tilt mechanism for chairs used by people with disabilities, according to claim 1, wherein said right mechanism base includes a roller track, a friction locking knob attachment plate with no friction knob attached thereto, a rear mounting bracket, a rear roller, and a front mounting bracket, wherein said front mounting bracket includes a crank handle, further wherein said crank handle comprises a locking crank handle, a crank handle arm and a front roller.

6. The seat tilt mechanism for chairs used by people with disabilities, according to claim 2, wherein said left mechanism base includes a roller track, a friction locking knob attachment plate with no friction knob attached thereto, a rear mounting bracket, a rear roller, and a front mounting bracket, wherein said front mounting bracket includes a crank handle, further wherein said crank handle comprises a locking crank handle, a crank handle arm and a front roller.

7. The seat tilt mechanism for chairs used by people with disabilities, according to claim 1, further including a chair base frame and wherein said rack and spur gear mechanism and a spur gear housing further comprises a gear rack pivotally attached to a mounting block attached to said chair base frame.

8. The seat tilt mechanism for chairs used by people with disabilities, according to claim 1, wherein said right and left tilt mechanism bases and said rack and spur gear mechanism are integrated into a toileting/shower chair used by people with disabilities.

9. The seat tilt mechanism for chairs used by people with disabilities, according to claim 8, wherein said toileting/shower chair further includes pivotally attached armrests that can be swung upwardly out of the way of the user.

10. The seat tilt mechanism for chairs used by people with disabilities, according to claim 8, wherein said toileting/shower chair further includes adjustably and pivotally attached footrests that can be height adjusted and swung upwardly out of the way of the user.

11. A method for making a seat tilt mechanism for chairs used by people with disabilities, comprising the steps of:
(a) providing right and left tilt mechanism bases, wherein said right mechanism base includes a roller track, a friction locking knob, a friction locking knob attachment plate, a rear mounting bracket, a rear roller, and a front mounting bracket, wherein said front mounting bracket includes a crank handle, a crank handle arm and a front roller;
(b) providing a rack and spur gear mechanism further comprising a gear rack pivotally attached to a mounting block attached to the chair base frame, and a spur gear housing attached to said front mounting bracket;
(c) providing a left side of the of the seat tilt mechanism being symmetrical with the right side having a rear mounting bracket and a left side front mounting bracket, with the omission of the rack and spur gear mechanism; and
(d) providing a curved slot that runs parallel to the curvature of the roller track on both the right and left tilt mechanism bases which functions as a retainer where the rear guide member on the rear mounting brackets and forward guide member on the front mounting bracket hold the seat frame from coming off the chair;
whereby said rack and spur gear mechanism is rotated using said crank handle to actuate tilting of the chair angle.

12. The method for making a seat tilt mechanism for chairs used by people with disabilities, according to claim 11, further comprising the steps of providing said right and left tilt mechanism bases that are reversed in position, wherein said left mechanism base includes a roller track, a friction locking knob, a friction locking knob attachment plate, a rear mounting bracket, a rear roller, and a front mounting bracket, wherein said front mounting bracket includes a crank handle, a crank handle arm and a front roller.

13. The method for making a seat tilt mechanism for chairs used by people with disabilities, according to claim 11, further comprising the steps of providing a right mechanism base wherein said right mechanism base includes a roller track, a friction locking knob, a friction locking knob attachment plate, a rear mounting bracket, a rear roller, and a front mounting bracket, wherein said front mounting bracket includes a crank handle, further wherein said crank handle comprises a locking crank handle, a crank handle arm and a front roller.

14. The method for making a seat tilt mechanism for chairs used by people with disabilities, according to claim 12, further comprising the steps of providing a left mechanism base wherein said left mechanism base includes a roller track, a friction locking knob, a friction locking knob attachment plate, a rear mounting bracket, a rear roller, and a front mounting bracket, wherein said front mounting bracket includes a crank handle, further wherein said crank handle comprises a locking crank handle, a crank handle arm and a front roller.

15. The method for making a seat tilt mechanism for chairs used by people with disabilities, according to claim 11, further comprising the steps of providing a wherein said right mechanism base includes a roller track, a friction locking knob attachment plate with no friction knob attached thereto, a rear mounting bracket, a rear roller, and a front mounting bracket, wherein said front mounting bracket includes a crank handle, further wherein said crank handle comprises a locking crank handle, a crank handle arm and a front roller.

16. The method for making a seat tilt mechanism for chairs used by people with disabilities, according to claim 12, further comprising the steps of providing a left mechanism base wherein said left mechanism base includes a roller track, a friction locking knob attachment plate with no friction knob attached thereto, a rear mounting bracket, a rear roller, and a front mounting bracket, wherein said front mounting bracket includes a crank handle, further wherein said crank handle comprises a locking crank handle, a crank handle arm and a front roller.

17. The method for making a seat tilt mechanism for chairs used by people with disabilities, according to claim 11, further comprising the steps of including a chair base frame and wherein said rack and spur gear mechanism and a spur gear housing further comprises a gear rack pivotally attached to a mounting block attached to said chair base frame.

18. The method for making a seat tilt mechanism for chairs used by people with disabilities, according to claim 11, further comprising the steps of providing said right and left tilt mechanism bases and said rack and spur gear mechanism that are integrated into a toileting/shower chair used by people with disabilities.

19. The method for making a seat tilt mechanism for chairs used by people with disabilities, according to claim 18, further comprising the steps of providing said toileting/shower chair which includes pivotally attached armrests that can be swung upwardly out of the way of the user, and adjustably and pivotally attached footrests that can be height adjusted and swung upwardly out of the way of the user.

20. The method for using a seat tilt mechanism for chairs used by people with disabilities, to reverse the side having the seat tilt mechanism thereon, comprising the steps of:
a) detaching the pivot block from the chair frame or chair surface that it is mounted to;
b) unscrewing the flange head screw on the inside of the gear crank mechanism from the gear crank shaft;
c) detaching the gear crank handle and shaft as one unit from the crank mechanism by pulling the unit out from the crank handle side;
d) sliding without rotating the main gear mechanism to the inside of the opposite curved track;
e) mounting the pivot block;
f) lining up the inside hole of the gear mechanism with axle hole on the front left side forks; and
g) inserting the shaft with handle attached through the left side front fork axle hole then into the indexed hole in the spur gear, and sliding it all the way through and securing in place by screwing in the flange head screw.
